(19) United States
(12) Patent Application Publication
(10) Pub. No.: US 2003/0057039 A1
(43) Pub. Date: Mar. 27, 2003

(54) Brake shoe formed of sheet metal and method of producing the same

(75) Inventors: Toshiaki Kanemitsu, Kobe-shi (JP); Kazuyuki Oda, Kako-gun (JP)

Correspondence Address: LARSON & TAYLOR, PLC, 1199 NORTH FAIRFAX STREET, SUITE 900, ALEXANDRIA, VA, 22314, US

(73) Assignee: PBR AUSTRALIA PTY LTD, East Bentleigh (AU)

(21) Appl. No.: 10/293,356

(22) Filed: Nov. 14, 2002

Related U.S. Application Data
(63) Continuation of application No. PCT/JP00/03078, filed on May 15, 2000.

(51) Int. Cl. F16D 69/00

(52) U.S. Cl. 188/250 B

(57) ABSTRACT

The present invention provides a brake shoe formed of sheet metal and allowing a brake lining to be firmly bonded, and a method of simply and inexpensively producing the brake shoe. The brake shoe is comprised of a shoe rim 11 formed in a cylinder having a circumference partially notched and an outer surface with a brake lining 10 bonded thereto, a pair of shoe ribs 12 extending from a vicinity of an inner, axially center circumference of shoe rim 11 radially inward toward each other, and an attachment plate 13 extending between paired ribs 12 radially inward, wherein shoe rim 11 has an outer surface knurled 14. The brake shoe is produced by: cleaving and spreading an outer peripheral portion of a metallic, disk-shaped blank 20 in a direction of a thickness of the sheet metal to form an intermediate, rolled product having a short cylindrical portion 33 and a web 34 extending radially inward from a vicinity of an inner, axially center circumference of cylindrical portion 33; subsequently pressing a knurling barrel 39 against an outer circumferential surface of cylindrical portion 33 to knurl 14 the outer circumferential surface of cylindrical portion 33; and punching the intermediate, rolled product to obtain brake shoe 1, shaped as described above.

### TECHNICAL FIELD

The present invention relates to brake shoes formed of sheet metal and methods of producing the same.

### BACKGROUND ART

A method of producing a brake shoe formed of sheet metal for use in a drum brake is disclosed for example in U.S. Pat. No. 5,440,796. The brake shoe disclosed therein has a cross section in the letter T and it is comprised of a shoe rim in an arc having an outer surface with a brake lining bonded thereto, and a shoe rib extending from an inner surface of the shoe rim radially inward. To produce the brake shoe, a blank in the form of a disk of metal is rolled to form an intermediate, rolled product having a short cylindrical portion and a web extending form an inner surface of the cylindrical portion radially inward and the intermediate product is punched and thus divided in two to obtain the above brake shoe having a cross section in the letter T and comprised of a shoe rim in an arc transformed from the cylindrical portion and a shoe rib in an arc transformed from the web.

Generally, to firmly bond a brake lining on an outer surface of the shoe rim of such a brake shoe, the outer surface is previously shot-blasted or ground with a grindstone to be a rough surface.

Shot-blasting or using a grindstone to roughen an outer surface of a shoe rim requires a step of roughening the surface that is essentially different from a step of rolling. As such, it is less productive and is also expensive.

The present invention contemplates a brake shoe formed of sheet metal and allowing a brake lining to be firmly bonded, and a method of simply and inexpensively producing the brake shoe.

### DISCLOSURE OF THE INVENTION

The present invention provides a brake shoe formed of sheet metal, including a shoe rim formed in a cylinder having a circumference partially notched and an outer surface with a brake lining bonded thereto, a pair of shoe ribs extending from a vicinity of an inner, axially center circumference of the shoe rim radially inward toward each other, and an attachment plate extending between the paired ribs radially inward, i.e., an integral brake shoe formed of sheet metal with an attachment plate, which is supported by a hub of an axle, formed integral with the brake shoe, the shoe rim having an outer surface knurled. The present invention in another aspect provides a brake shoe formed of sheet metal, including a shoe rim in an arc having an outer surface with a brake lining bonded thereto, and a shoe rib extending from a vicinity of an inner, axially center circumference of the shoe rim radially inward, the shoe rim having the outer surface knurled.

The present brake shoe with the shoe rim having the knurled outer surface allows the brake lining to be bonded across an increased surface area and also can prevent the lining from slipping. It can thus prevent the lining from peeling off and thus allows the lining to be bonded firmly.

The present invention provides a method of producing the above integral brake shoe formed of sheet metal, including the steps of: cleaving and spreading an outer peripheral portion of a metallic, disk-shaped blank in a direction of a thickness of the sheet metal to form an intermediate, rolled product having a short cylindrical portion and a web extending radially inward from a vicinity of an inner, axially center circumference of the cylindrical portion; subsequently pressing a knurling barrel against an outer circumferential surface of the cylindrical portion to knurl the outer circumferential surface of the cylindrical portion; and punching the intermediate, rolled product to obtain the brake shoe, shaped as described above.

In this method, rolling the blank can immediately be followed by knurling it. As such the method can simply and inexpensively produce a brake shoe formed of sheet metal and allowing a brake lining to be bonded more firmly than a method using shot-blasting or a grindstone to provide a rough surface.

The present invention in another aspect provides a method of producing a brake shoe formed of sheet metal, comprised of a shoe rim in an arc having an outer surface with a brake lining bonded thereto, and a shoe rib extending from a vicinity of an inner, axially center circumference of the shoe rim radially inward, the method including the steps of: cleaving and spreading an outer peripheral portion of a metallic, disk-shaped blank in a direction of a thickness of the sheet metal to form an intermediate, rolled product having a short cylindrical portion and a web extending radially inward from a vicinity of an inner, axially center circumference of the cylindrical portion; subsequently pressing a knurling barrel against an outer circumferential surface of the cylindrical portion to knurl the outer circumferential surface; and dividing the intermediate, rolled product into two pieces cooperating to form the brake shoe.

In this method also, rolling the blank can immediately be followed by knurling it. As such the method can simply and inexpensively produce a brake shoe formed of sheet metal and allowing a brake lining to be bonded more firmly.

The above intermediate, rolled product is formed preferably as described in PCT/JP00/01447 by cleaving an outer peripheral portion of a metallic, disk-shaped blank in two in the direction of the thickness of the sheet metal and spreading the cleft portion to provide the intermediate product with a short cylindrical portion and a web extending radially inward from a vicinity of an inner, axially center circumference of the cylindrical portion. Furthermore, it is also preferable that the method includes the steps of: pressing against the outer peripheral portion of the blank a preforming roller dice at a groove extending on a circumferential surface of the roller dice circumferentially and having a width larger than the thickness of the blank and at an edge provided in the groove at a bottom and protruding circumferentially for forming a groove to allow the edge to provide the blank at an entirety of the outer peripheral portion with a circumferential groove; and pressing against the circumferential groove of the blank a cleaving and spreading roller dice at a cleaving and spreading edge formed on a circumferential surface of the cleaving and spreading roller dice and protruding circumferentially to divide and thus spread the outer peripheral portion of the blank in two in the direction of the thickness of the sheet metal to form the intermediate, rolled product having the short cylindrical portion and the web. In the present method the blank's outer peripheral portion can be divided precisely and accurately in the direction of the thickness of the sheet metal in two and thus spread.

### BRIEF DESCRIPTION OF THE DRAWINGS

In the drawings:

FIG. 1 is a front view of a brake shoe formed of sheet metal;

FIG. 2 is a side view of the brake shoe;

FIG. 3 is a side view of the brake shoe in another embodiment;

FIG. 4 is a side view of the brake shoe in still another embodiment;

FIG. 5 is a front view of the brake shoe in another embodiment;

FIG. 6 is a side view of the FIG. 5 brake shoe;

FIG. 7A shows a condition prior to the preforming step for producing the brake shoe;

FIG. 7B illustrates the preforming step;

FIG. 8 is a partial cross section of a preforming roller dice in another example;

FIG. 9A shows a condition prior to the cleaving and spreading step for producing the brake shoe;

FIG. 9B illustrates the cleaving and spreading step;

FIG. 10A shows a condition prior to a step preceding the step of completing a short cylindrical portion for producing the brake shoe;

FIG. 10B illustrates the step preceding the step of completing the cylindrical portion;

FIG. 11A shows a condition prior to the step of completing the cylindrical portion;

FIG. 11B illustrates the step of completing the cylindrical portion;

FIG. 12A shows a condition prior to the knurling step for producing the brake shoe;

FIG. 12B illustrates the knurling step;

FIG. 13 is a front view of the brake shoe for illustrating the punching step for producing the brake shoe;

FIG. 14 is a front view of the brake shoe in another embodiment for illustrating the punching step for producing the brake shoe;

FIG. 15A illustrates the cleaving and spreading step for producing the brake shoe in another embodiment; and

FIG. 15B illustrates the step of completing the short cylindrical portion for producing the brake shoe in another embodiment.

### BEST MODES FOR CARRYING OUT THE INVENTION

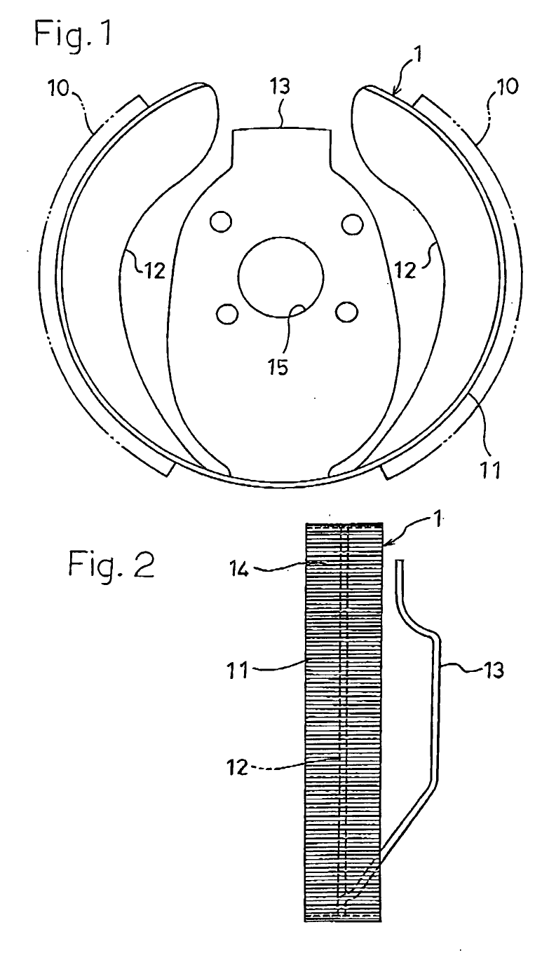

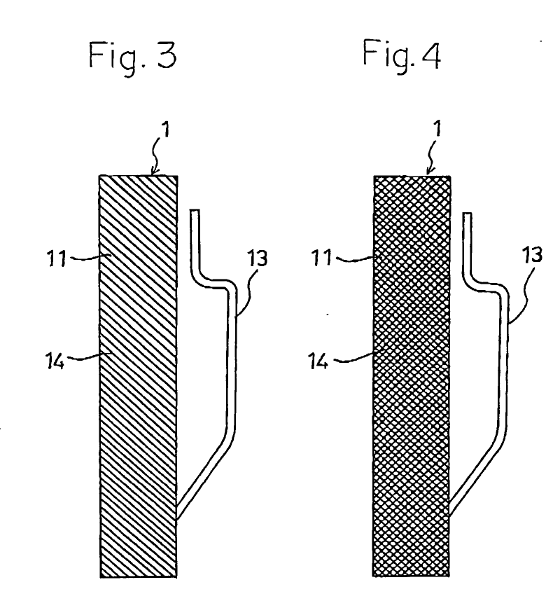

The present invention in one embodiment provides a brake shoe 1 formed of sheet metal for use in a leading trailing drum brake, and, as shown in FIGS. 1 and 2, it is comprised of a shoe rim 11 formed in a cylinder having a circumference partially notched and an outer surface with a brake lining 10 bonded thereto, a pair of arcuate shoe ribs 12 extending from a vicinity of an inner, axially center circumference of shoe rim 11 radially inward toward each other, and an attachment plate 13 in the form of a tongue extending between paired ribs 12 radially inward. These components are integrally formed to provide the structure. Shoe rim 11 has an outer surface knurled 14 to allow brake lining 10 to be bonded more firmly. As shown in FIG. 2, shoe rim 11 has its outer surface knurled 14 to have a large number of lines extending axially. As shown in FIG. 3, it is knurled 14 obliquely. As shown in FIG. 4, it is knurled 14 to be cross hatched. Attachment plate 13 is provided with a hub supporting hole 15 for support by a hub of an axle.

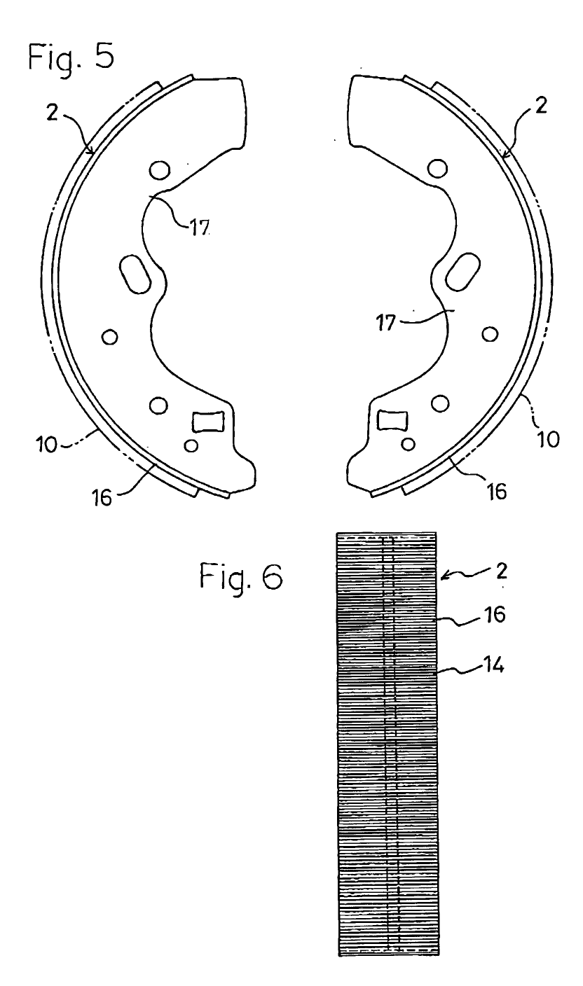

Furthermore, a brake shoe 2, as shown in FIGS. 5 and 6 in another embodiment, has a shoe rim 16 in an arc having an outer surface with brake lining 10 bonded thereto, and a shoe rib 17 extending from a vicinity of an inner, axially center circumference of shoe rim 16 radially inward. Shoe rim 16 also has an outer surface knurled 14. If brake shoe 2 is used in a drum brake, two brake shoes 2 are paired and they are mounted such that they are pressed against an inner surface of a cylindrical drum of a wheel.

Brake shoe 1 and 2 formed of sheet metal thus structured is produced through a rolling step for example including a preforming step, a cleaving and spreading step and a step of forming a short cylindrical portion, a knurling step, and a punching step.

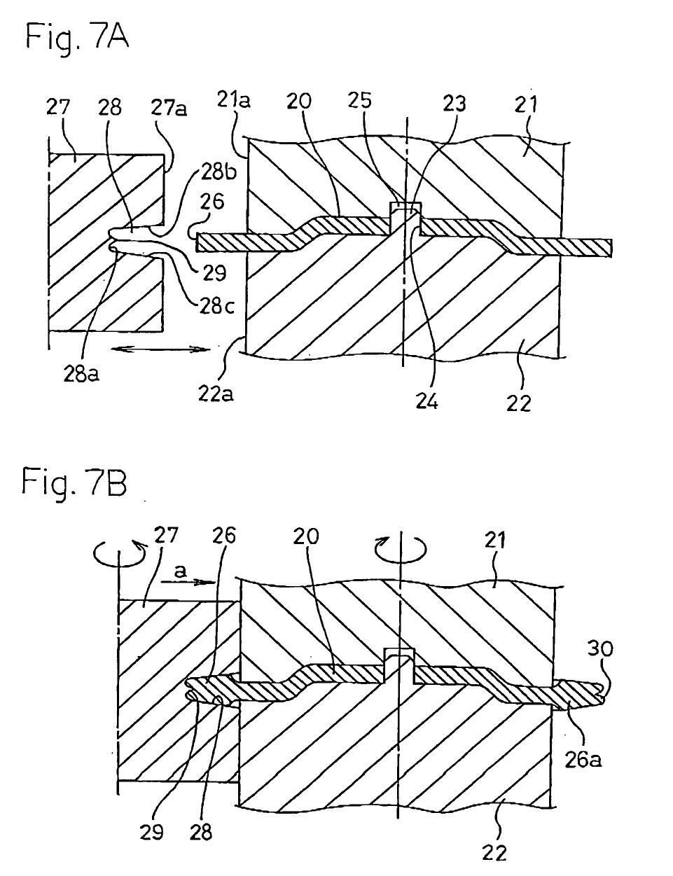

The brake shoe is produced from a blank 20 provided by blanking a steel plate or any other similar sheet metal in a disk. Initially, as shown in FIG. 7A, in the preforming step blank 20 is clamped by and held between a top rotative die 21 and a bottom rotative die 22. Bottom die 22 at its axis has a protrusion 23 passing through a center hole 24 of blank 20 to engage with a depression 25 provided in upper die 21 at the center. Blank 20 has an outer peripheral portion 26 protruding outer than outer circumferential surfaces 21a and 22a of top and bottom dies 21 and 22, respectively, by a predetermined length.

In the preforming step a preforming roller dice 27 is used. Roller dice 27 has a circumferential surface 27a provided with a groove 28 running circumferentially and having a width larger than the thickness of blank 20 and a bottom 28a provided with a groove forming edge 29 protruding circumferentially and having a cross section in the letter V of a small size. Groove 28 has side walls 28b and 28c inclining to gradually widen the groove outward to provide a cross section in the letter V to help the groove to receive portion 26 in the preforming step. Alternatively, groove 28 may have side walls 28b and 28c both extending orthogonal to the axis in parallel to provide a cross section in the letter U and having their respective opening edges rounded.

In the preforming step, roller dice 27 is moved, as indicated in FIG. 7B by an arrow α, to be adjacent to portion 26. Groove 28 and edge 29 are pressed against portion 26, while roller dice 27 and blank 20 are synchronously rotated. Edge 29 thus provides portion 26 with a circumferential groove 30.

If in doing so blank 20 that is used has a small thickness and it is desired that its outer peripheral portion 26 is formed in groove 28 to have an increased thickness, groove 28 that is dimensioned to have a width and a depth to be able to increase portion 26 in thickness can readily form portion 26 increased in thickness, since groove 28 allows material to flow therein as roller dice 27 is pressed against it. If groove 28 has a cross section in the letter V, portion 26 can be increased in thickness with its foot 26a having a largest thickness.

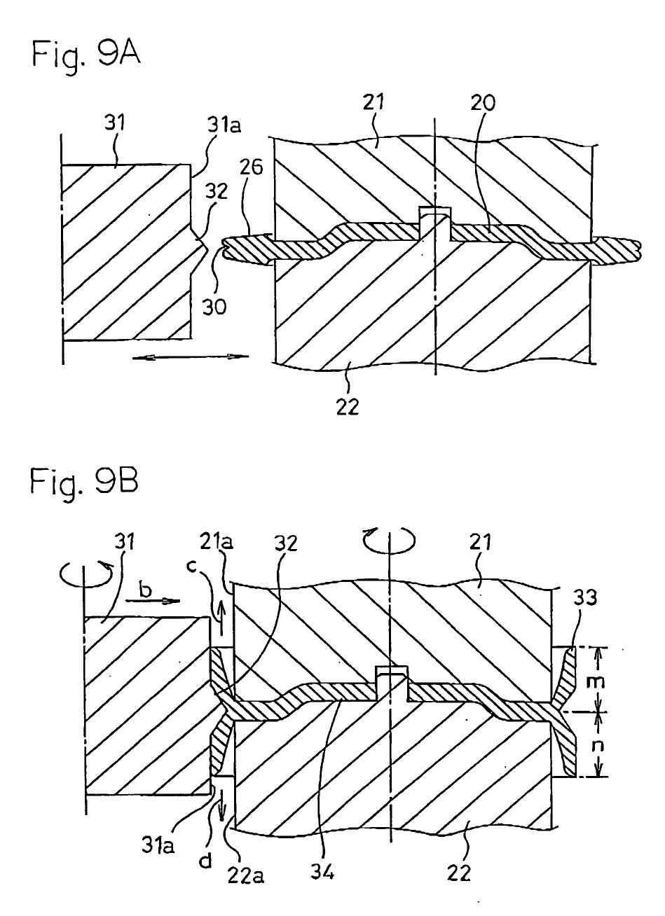

Blank 20 having outer peripheral portion 26 provided with circumferential groove 30 then undergoes a cleaving and spreading step, as shown in FIG. 9A. A cleaving and spreading roller dice 32 having a circumferential surface 31a provided with a cleaving and spreading edge 32 having a cross section in the letter V and protruding circumferentially, is moved, as indicated in FIG. 9B by an arrow b, to be adjacent to outer peripheral portion 26 of blank 20 to press edge 32 against circumferential groove 30 blank 20. Edge 32 thus cleaves portion 26 in two in the direction of the thickness of the sheet metal to allow the material to flow between circumferential surface 31a of roller dice 31 and outer circumferential surfaces 21a and 22a of rotative, top an bottom dies 21 and 22 in the direction of the thickness of the sheet metal, as indicated by two arrows c and d, to form a short cylindrical portion 33 and a web 34 extending radially inward from a vicinity of an inner, axially center circumference of cylindrical portion 33.

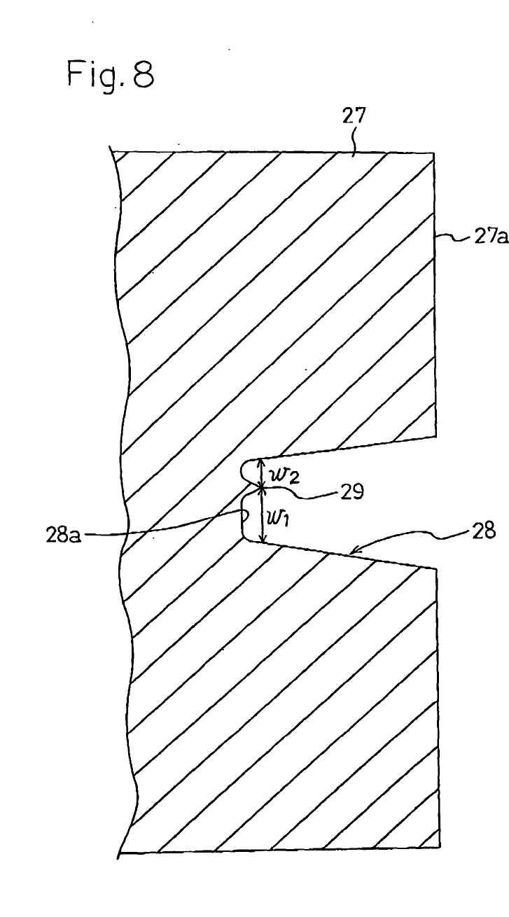

If in doing so it is desired that portion 26 is spread to allow cylindrical portion 33 on one side of web 34 and that on the other side of the web to have their respective axial lengths m and n equalized, preforming roller dice 27 that is provided with groove forming edge 29 in groove 28 at bottom 28a at a center as seen in the direction of the width of the groove would be used in the preforming step to provide portion 26 with groove 30 at a center as seen in the direction of the thickness of the sheet metal. If it is desired that portion 26 is spread to provide lengths m and n having different values, then roller dice 27 having edge 29 formed in groove 28 at bottom 28a at a position offset from a center as seen in the direction of the width of the groove, would be used in the preforming step to provide portion 26 with groove 30 at a position offset from a center as seen in the direction of the thickness of the sheet metal. For example, as shown in FIG. 8, if roller dice 27 has edge 29 in groove 28 at bottom 28a that is positioned to provide w₁:w₂=2:1, portion 26 can be spread to provide lengths m:n=1:2.

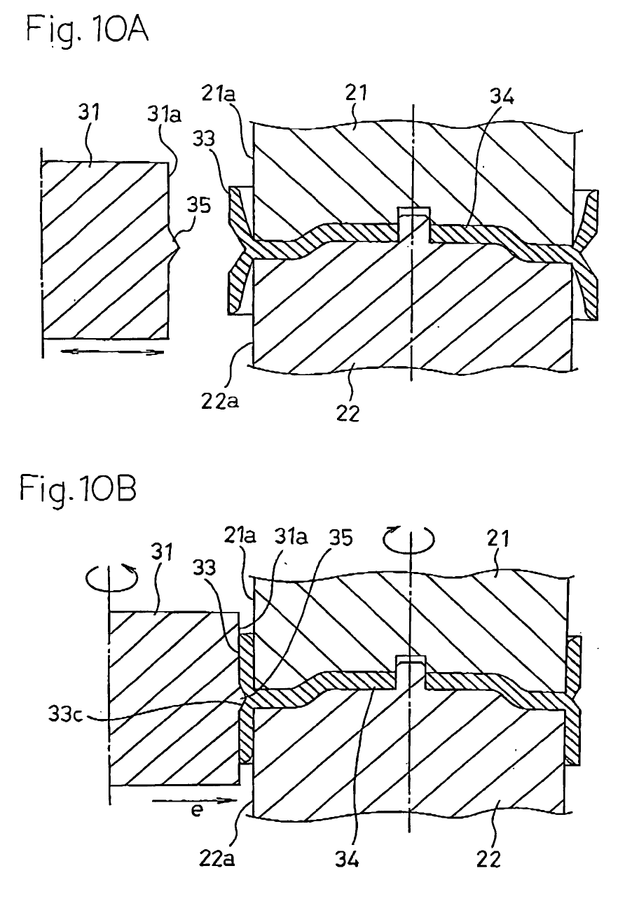

If providing the cleaving and spreading step only once is insufficient to allow cylindrical portion 33 to have a right angle relative to web 34 and be uniform in thickness, as shown in the figure, the cleaving and spreading step is provided once more or more. This is done by using cleaving and spreading roller dice 31 having a cleaving and spreading edge 35 on circumferential surface 31a. Note that edge 35 has a smaller cross section in the letter V than cleaving and spreading edge 32. Roller dice 31 is moved, as indicated in FIG. 10B by an arrow e, to be adjacent to cylindrical portion 33 to press edge 35 against cylindrical portion 33 at a center depression 33a so that between circumferential surface 31a of roller dice 31 and outer circumferential surfaces 21a and 22a of rotative, top and bottom dies 21 and 22 cylindrical portion 33 can be shaped to have a right angle relative to web 34 and also be uniform in thickness.

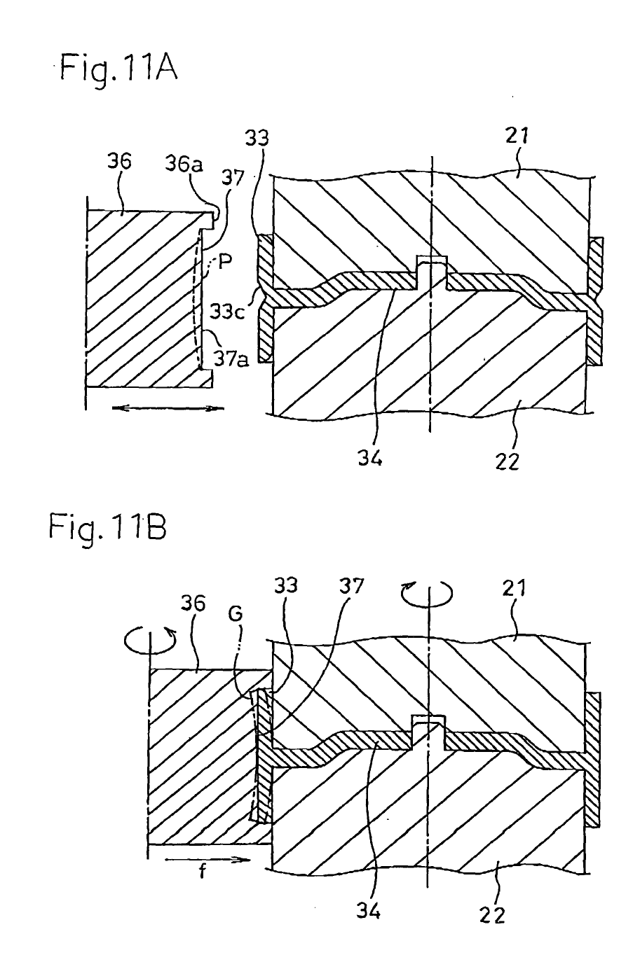

The intermediate product then undergoes the step of completing the short cylindrical portion. As shown in FIG. 11A, a finishing roller dice 36 has a circumferential surface 36a provided with a groove 37 circumferentially running for correcting an axial length. Roller dice 26 is moved, as indicated in FIG. 11B by an arrow f, to be adjacent to short cylindrical portion 33 to press groove 37 against cylindrical portion 33 to complete cylindrical portion 33 having a predetermined axial length. If in doing so cylindrical portion 33 still has a depression 33c at the center, as shown in FIG. 11A, depression 33c is also removed. Note that preferably, groove 37 that has a bottom surface 37a rounded by approximately 200R, as indicated in FIG. 11A by a broken line P, rather than in a vertical plane parallel to the axis, and thus has an axial center with a narrow center, is applied to complete cylindrical portion 33 to be axially straight, preventing the cylinder portion from warping due to residual strain, as indicated in FIG. 11B by a virtual line G.

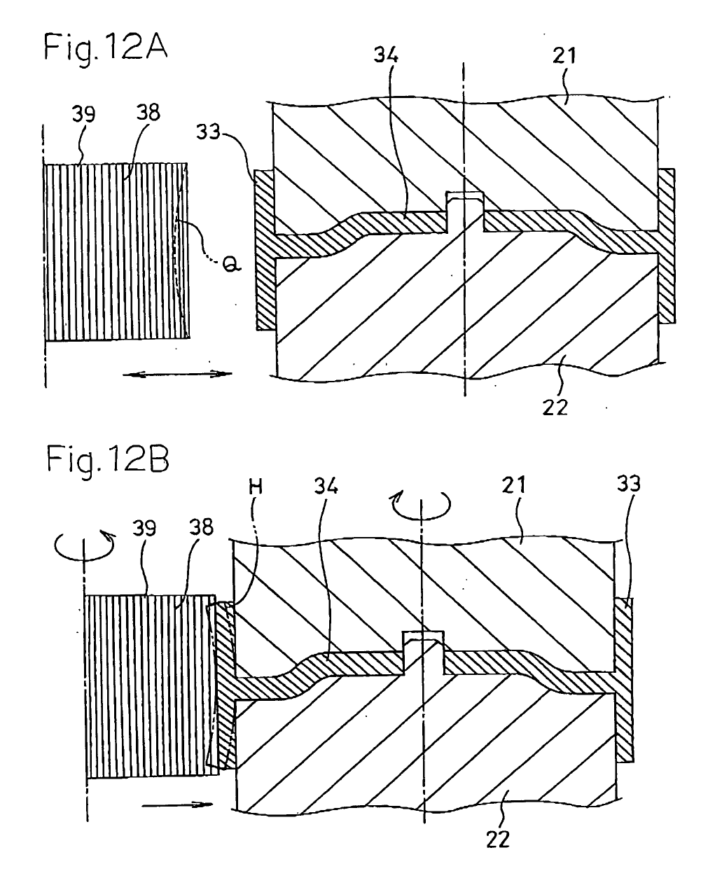

The intermediate, rolled product thus having short cylindrical portion 33 and web 34 extending radially inward from a vicinity of an inner, axially center circumference of cylindrical portion 33, is then knurled. With reference to FIG. 12A, a knurling barrel 39 having a circumferential surface knurled 38 is prepared, and it is pressed against the intermediate product at cylindrical portion 33 on an outer circumferential surface and also rotated with the intermediate product to knurl 14 the intermediate product. Note that preferably barrel 39 has a circumferential surface having approximately 200R, as indicated in FIG. 12A by a broken line Q, rather than in a vertical plane parallel to the axis, to complete cylindrical portion 33 to be axially straight, preventing the cylindrical portion from warping due to residual strain, as indicated in FIG. 12B by a virtual line H.

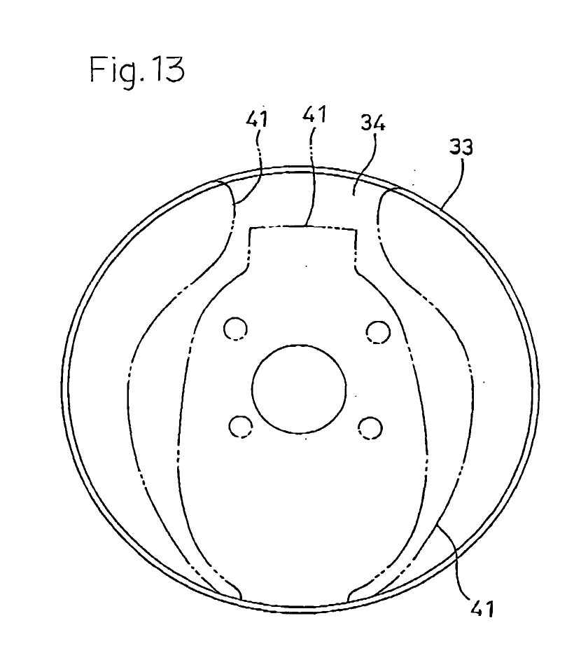

The intermediate, rolled product having a short cylindrical portion 33 with an outer circumferential surface knurled 14 and web 34, is then illuminated with a laser beam or blown out by plasma, as shown in FIG. 13, so that it is punched along a cutting line 41 to have a required geometry to provide brake shoe 1 formed of sheet metal, as shown in FIG. 1, a structure formed of shoe rim 11 in a notched cylinder transformed from short cylindrical portion 33, a pair of shoe ribs 12 in an arc transformed from web 34, and attachment plate 13 transformed in the form of a tongue and for example having hub supporting hole 15 that are formed integrally.

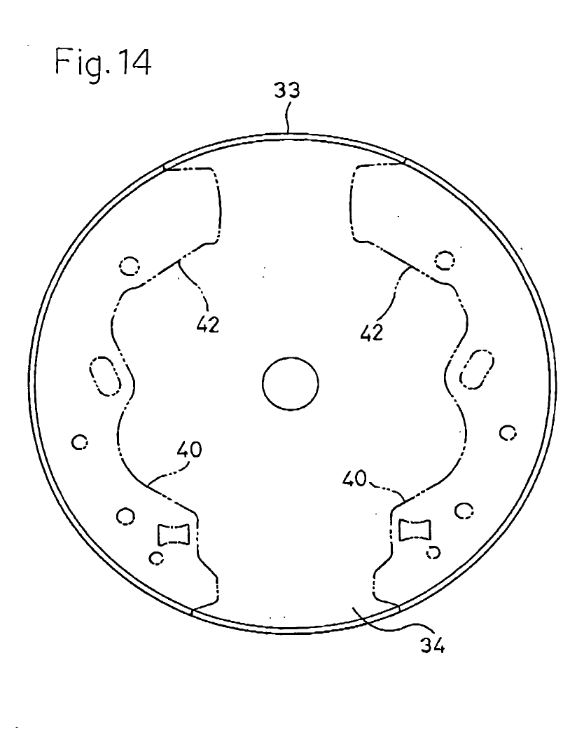

Furthermore the above intermediate, rolled product, as shown in FIG. 14, is punched along a cutting line 42 to have a required geometry to provide two pieces 40 forming brake shoe 2 formed of sheet metal, shaped as shown in FIG. 5, including shoe rim 16 in an arc transformed from short cylindrical portion 33 and shoe rib 17 in an arc transformed from web 34.

Then, as shown in FIGS. 1 and 5, brake lining 10 is bonded with adhesive on outer surfaces respectively of shoe rims 11 and 16 of brake shoes 1 and 2, respectively. Since shoe rims 11 and 16 have their respective outer surfaces knurled 14, brake lining 10 can be bonded firmly.

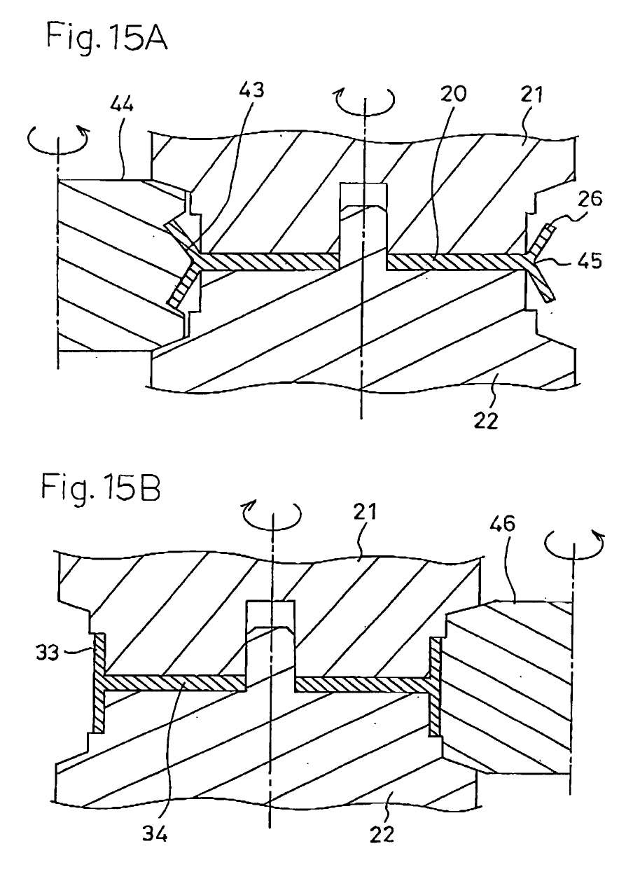

The intermediate, rolled product formed of short cylindrical portion 33 and web 34 can also be produced through the following rolling step: as shown in FIG. 15A, blank 20 formed in a disk is clamped by and thus held between rotative, top and bottom dies 21 and 22 with its outer peripheral portion 26 protruding from the dies. Then, a slitting roller dice 44 having a circumference provided with an edge 43 is pressed against blank 20 at outer peripheral portion 26 and roller dice 44 and blank 20 are also rotated synchronously to slit portion 26 in the direction of the thickness of the sheet metal to form a groove 45 opening in the letter V. Then, as shown in FIG. 15B, a cleaving and spreading roller 46 is pressed against rotating blank 20 at groove 45 to vertically spread groove 45 to obtain an intermediate, rolled product having short cylindrical portion 33 and web 34. Thereafter, cylindrical portion 33 has an outer circumferential surface knurled 14 or the intermediate product is punched to have a required geometry to form brake shoe 1 or 2 shaped as above, as described in the above embodiment.

### INDUSTRIAL APPLICABILITY

In accordance with the present invention a brake shoe formed of sheet metal that allows a brake lining to be firmly bonded can be produced simply and inexpensively.

1. A brake shoe formed of sheet metal, comprising a shoe rim formed in a cylinder having a circumference partially notched and an outer surface with a brake lining bonded thereto, a pair of shoe ribs extending from a vicinity of an inner, axially center circumference of said shoe rim radially inward toward each other, and an attachment plate extending between said paired ribs radially inward, said shoe rim having said outer surface knurled.

2. A brake shoe formed of sheet metal, comprising a shoe rim in an arc having an outer surface with a brake lining bonded thereto, and a shoe rib extending from a vicinity of an inner., axially center circumference of said shoe rim radially inward, said shoe rim having said outer surface knurled.

3. A method of producing a brake shoe formed of sheet metal, including a shoe rim formed in a cylinder having a circumference partially notched and an outer surface with a brake lining bonded thereto, a pair of shoe ribs extending from a vicinity of an inner, axially center circumference of said shoe rim radially inward toward each other, and an attachment plate extending between said paired ribs radially inward, the method comprising the steps of:
cleaving and spreading an outer peripheral portion of a metallic, disk-shaped blank in a direction of a thickness of the sheet metal to form an intermediate, rolled product having a short cylindrical portion and a web extending radially inward from a vicinity of an inner, axially center circumference of said cylindrical portion;
subsequently pressing a knurling barrel against an outer circumferential surface of said cylindrical portion to knurl said outer circumferential surface; and
punching said intermediate, rolled product to obtain the brake shoe, shaped as described above.

4. The method of claim 3, wherein the step of cleaving and spreading includes the steps of:
pressing against said outer peripheral portion of said blank a preforming roller dice at a groove extending on a circumferential surface of said roller dice circumferentially and having a width larger than the thickness of said blank and at an edge provided in said groove at a bottom and protruding circumferentially for forming a groove to allow said edge to provide said blank at an entirety of said outer peripheral portion with a circumferential groove; and
pressing against said circumferential groove of said blank a cleaving and spreading roller dice at a cleaving and spreading edge formed on a circumferential surface of said cleaving and spreading roller dice and protruding circumferentially to divide and thus spread said outer peripheral portion of said blank in two in the direction of the thickness of the sheet metal to form said intermediate, rolled product having said short cylindrical portion and said web.

5. A method of producing a brake shoe formed of sheet metal, including a shoe rim in an arc having an outer surface with a brake lining bonded thereto, and a shoe rib extending from a vicinity of an inner, axially center circumference of said shoe rim radially inward, the method comprising the steps of:
cleaving and spreading an outer peripheral portion of a metallic, disk-shaped blank in a direction of a thickness of the sheet metal to form an intermediate, rolled product having a short cylindrical portion and a web extending radially inward from a vicinity of an inner, axially center circumference of said cylindrical portion;
subsequently pressing a knurling barrel against an outer circumferential surface of said cylindrical portion to knurl said outer circumferential surface; and
dividing said intermediate, rolled product into two pieces cooperating to form said brake shoe.

6. The method of claim 5, wherein the step of cleaving and spreading includes the steps of:
pressing against said outer peripheral portion of said blank a preforming roller dice at a groove extending on a circumferential surface of said roller dice circumferentially and having a width larger than the thickness of said blank and at an edge provided in said groove at a bottom and protruding circumferentially for forming a groove to allow said edge to provide said blank at an entirety of said outer peripheral portion with a circumferential groove; and
pressing against said circumferential groove of said blank a cleaving and spreading roller dice at a cleaving and spreading edge formed on a circumferential surface of said cleaving and spreading roller dice and protruding circumferentially to divide and thus spread said outer peripheral portion of said blank in two in the direction of the thickness of the sheet metal to form said intermediate, rolled product having said short cylindrical portion and said web.
